(19) United States
(12) Patent Application Publication
(10) Pub. No.: US 2024/0208838 A1
(43) Pub. Date: Jun. 27, 2024

(54) METHOD AND SYSTEM FOR SYNTHESIZING A LITHIUM-BASED OXIDE (LBO) ANODE MATERIAL FOR BATTERY APPLICATIONS

(71) Applicant: Indian Institute of Technology Delhi, New Delhi (IN)

(72) Inventors: Madhusudan Singh, New Delhi (IN); Tejveer Singh Anand, New Delhi (IN); Henam Sylvia Devi, New Delhi (IN)

(21) Appl. No.: 18/393,750

(22) Filed: Dec. 22, 2023

(30) Foreign Application Priority Data
Dec. 22, 2022 (IN) 202211074423

(51) Int. Cl. C01G 23/04

(52) U.S. Cl. CPC C01G 23/043

(57) ABSTRACT

The present disclosure provides a method (100) and system (200) for synthesizing a lithium-based oxide (LBO) anode material. The method (100) includes dissolving (102), LiOAc (Lithium acetate dihydrate) in a solvent under constant stirring at a temperature range of 50-70° C., preparing (104), a solution mixture by dissolving a salt or compound in the solvent, allowing (106), the solution mixture to react for a first predefined time under constant stirring, adding (108), continuously a homogenous solution into the solution mixture to activate the reaction, carrying (110), out the reaction for a second predefined time at a temperature range of 45-70° C. under constant stirring, collecting (112), powder sample of LBO anode material by drying the solution mixture at 70-90° C. in air for a third predefined time, and annealing (114), the dried powder sample at a temperature range of 700-850° C. for a fourth predefined time in the air.

### CROSS-REFERENCE TO RELATED APPLICATIONS

The present application claims priority from Indian Patent Application No. 202211074423 filed on Dec. 22, 2022, the contents of which are incorporated by reference herein in their entirety.

### TECHNICAL FIELD

The present disclosure generally relates to field of battery technology. More particularly, the present disclosure relates to method and system for synthesizing of lithium based oxide (LBO) anode material for battery applications, where the lithium based oxide (LBO) anode material are Li₃VO₄ or Li₄Ti₅O₁₂.

### BACKGROUND

In today's market, the electronic era, rechargeable lithium-ion batteries (LIBs) have drawn substantial interest in energy storage due to their manifest advantages in various electronic devices extending from portable electronics like cameras, laptops, smart watches, etc., to the rapid commercialization of electric vehicles (EV) and hybrid electric vehicles (HEV), and many other energy storage systems. Batteries must always have higher energy and power density, increased safety, and excellent large current charging-discharging properties to power large-scale applications. Rapid use of graphite anodes in the present commercial market still needs to be improved by poor performance and safety issues, mainly due to the instability of the electrode materials. As conventionally known graphite electrode, unfortunately, suffers from high lithium dendrites formation and large polarization during lithiation, ultimately leading to capacity fading.

At low voltage limits, a significant reduction of the organic components in the electrolyte occurs, leading to the formation of a passivated solid electrolyte interface (SEI) layer on the surface of the graphite electrode during the initial few cycles. The formation of the stable SEI is necessary for the working of electrodes because in order to avoid the reaction of electrolytes at the surface of the electrode material causing the formation of a thick SEI layer which impedes the intercalation and deintercalation of the Li+ ions during subsequent charging and discharging, leading to the poor cycle performance of the battery, i.e., it leads to irreversible capacity loss during initial cycles due to the permanent trapping of Li-ions inside the electrode. Further, graphite anodes undergo severe volumetric expansion during cycling, resulting in poor adhesion and peeling off the coated slurry from the current collector and resulting in a short circuit case. Also, the graphite anodes lack inherent safety due to the low intercalation potential of Li+ ions. In such cases, research efforts have been directed toward the rational design of long-cycle stability and high-rate capability type anode materials, i.e., Li₄Ti₅O₁₂ (LTO) which is an example of zero-strain material due to its insignificant volume expansion even during high C-rates, thus making it a promising anode material when compared against existing graphite structure. Moreover, LTO provides three-dimensional network pathways for diffusion of Li+ ions inside the structure which accounts for the phase transition during lithiation and demonstrates a theoretical capacity of 175 mAhg⁻¹ and relatively higher potential vs. Li+ ions ˜1.55 V, which accounts for the increased safety concerned of the device.

Some measures have been taken to alleviate the electrochemical performance of LTO by modulating different morphologies, but somehow limit its potential use as a commercial end product due to complex synthesis route followed which also includes the use of surfactant and other capping agents leading to increase in the overall cost. In addition to above recently Li₃VO₄ due to its superior performance in the lithium-ion battery (LIBs), safe working potential, higher energy density, and high theoretical capacity of ˜594 mAhg⁻¹ has attracted much attention as a new insertion type anode material for LIBs. LVO intercalates lithium ions at a lower potential of 0.5-1V than LTO. Furthermore, LVO has high ionic conductivity but suffers low electronic conductivity and large resistance polarization, which results in poor cycling and rate performance, preventing this from being widely used as a conventional material of batteries. Such disadvantages over the use of LVO can be improved using an appropriate binder and conductive fillers like MWCNT/SWCNT. Various morphologies of LVO have been reported to date, like carbon coated core-shell LVO, nanorods, mesoporous supported LVO structures, and other such structures, in various attempts to address the two aforementioned disadvantages of LVO.

International Advanced Research Centre for powder Metallurgy and New Materials (ARCI) team-DST, the government of India in its patent application WO2018154595A1 (hereinafter referred to as “P1”) has recently reported a simple, economical, scalable, and energy-efficient technique for the production of LTO anode with improved electronic conductivity using TiO₂ and Li₂CO₃ as precursors through high energy milling method having advantages of short processing time, low contamination, the increased relative velocity of balls, high energy input and adaptable to any precursors.

Another prior-art document D. D. Sloovere et al., “Combustion synthesis as a low temperature route to Li₄Ti₅O₁₂ based powders for lithium ion battery anodes,” RSC Adv., vol. 7, no. 30, pp. 18745-18754, March 2017, (hereinafter referred to as “P2”), provides the synthesis of LTO using titanium isopropoxide, lithium nitrate, lactic acid, NH₄NO₃ and water. The hydrolysis and condensation process was carried out by adding 300 ml water to the titanium isopropoxide. Lactic acid was added to the residue in a 3:1 molar ratio with 40 mL water. The mixture was refluxed at 80° C. until the residue was dissolved entirely. Ammonia (35%) was added to the obtained solution at room temperature to increase the pH to 6.8. The multi-metal ion solutions were dried at 60° C. for 12 hours until a viscous gel formed. The dried precursor samples were heated at 300° C. under an oxygen atmosphere in a preheated tube furnace. The dried powder was heated at 600° C. to obtain the desired product. However, this prior-art document, due to requirement of refluxing, pH maintenance, and two-step heat treatment is costly.

Another prior-art document US20100301267A1 (hereinafter referred to as “P3”) provides a method of making lithium vanadium oxide powders using V₂O₅, Lithium hydroxide, and a reducing agent. The obtained product is crystallized at a high temperature of 1000° C. However, this prior-art document, due to requirement of V₂O₅, Lithium hydroxide, and a reducing agent is costly.

Yet another prior-art document CA2037047A1 (hereinafter referred to as “P4”) provides lithium vanadate as active material in the battery that uses ammonium vanadate, lithium hydroxide, and lithium nitrate as precursors for the synthesis. The desired material is obtained after extensive heating at 250-450° C. for 10-20 hrs. However, this prior-art document, due to requirement of ammonium vanadate, lithium hydroxide, and lithium nitrate as precursors is costly.

In view of the above problems associated with the state of the art, there is a need to provide an optimum solution that can obviate the limitations and provide an efficient and cost-effective method and system for synthesizing of lithium based oxide (LBO) anode material for battery applications, where the lithium based oxide (LBO) anode material are Li₃VO₄ or Li₄Ti₅O₁₂.

### Objects of the Present Disclosure

It is a primary object of the present disclosure to provide a solution-processed, low-cost, and surfactant-free synthesis route for the lithium based oxide (LBO) anode material for lithium-ion battery applications.

An object of the present disclosure is to provide a method for synthesizing lithium based oxide (LBO) anode material by establishing the relationship between reaction activation time and the observation of turbidity within a predefined time to ensure the timely initiation of the reaction.

An object of the present disclosure is to provide a method for optimizing the drying duration for collecting LBO powder samples and the subsequent annealing process for enhancing the crystallinity and electrochemical performance of the anode.

An object of the present disclosure is to provide a systematic approach to conduct electrochemical measurements in a half-cell configuration on the synthesized LBO anode material to evaluate its performance characteristics, including discharge capacity and stability over multiple cycles.

### SUMMARY

Aspects of the present disclosure generally relates to field of battery technology. More particularly, the present disclosure relates to method and system for synthesizing of lithium based oxide (LBO) anode material for battery applications.

According to an aspect, a method for synthesizing a lithium based oxide (LBO) anode material is disclosed. The method includes dissolving LiOAc (Lithium acetate dihydrate) in a solvent under constant stirring at a temperature range of 50-70° C. and preparing a solution mixture by dissolving a salt or compound in the solvent. In addition, the method further includes allowing the solution mixture to react for a first predefined time under constant stirring, adding continuously a homogenous solution into the solution mixture to activate the reaction, and carrying out the reaction for a second predefined time at a temperature range of 45-70° C. under constant stirring Further, the method includes collecting powder sample of LBO anode material by drying the solution mixture at 70-90° C. in air for a third predefined time and annealing the dried powder sample at a temperature range of 700-850° C. for a fourth predefined time in the air.

In an aspect, the solvent is selected from a group comprising ethanol, methanol, 2-methoxy ethanol, propanol or a combination thereof and the solvent volume is in the range of 10-20 mL.

In an aspect, the salt or compound dissolved in the solvent is selected from titanium butoxide or ammonium monovandate or a combination thereof.

In an aspect, turbidity is observed within a fifth predefined time to indicate the activation of reaction and the homogenous solution comprises a mixture of solvent and deionized water.

In an aspect, the lithium based oxide (LBO) anode material are Li₃VO₄ or Li₄Ti₅O₁₂.

In an aspect, the method further comprises conducting electrochemical measurement in a half-cell configuration on the synthesized LBO anode material to assess the performance of the synthesized LBO anode material. The half-cell configuration is a lithium titanate oxide (Li₄Ti₅O₁₂) half-cell configuration comprising a CR2016 cell configuration and a Li₄Ti₅O₁₂ anode delivering an initial discharge capacity exceeding a predefined discharge capacity within a potential voltage window.

According to another aspect, a system for synthesizing a lithium based oxide (LBO) anode material is disclosed. The system includes a vessel for dissolving LiOAc (Lithium acetate dihydrate) in a solvent under constant stirring at a temperature range of 50-70° C. and a container for preparing a solution mixture by dissolving a salt or compound in the solvent. In addition, the system further includes a reactor for allowing the solution mixture to react for a first predefined time under constant stirring, a dispensing means for continuously adding a homogenous solution into the solution mixture to activate the reaction, and a reaction chamber for carrying out the reaction for a second predefined time at a temperature range of 45-70° C. under constant stirring. Further, the system includes a collection chamber for collecting a powder sample of LBO anode material by drying the solution mixture at 70-90° C. in air for a third predefined time and an annealing chamber for annealing the dried powder sample at a temperature range of 700-850° C. for a fourth predefined time in the air.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates an exemplary flow diagram of the proposed method for synthesizing a lithium based oxide (LBO) anode material, in accordance with the embodiments of the present disclosure.

FIG. 2 illustrates an exemplary block diagram of the proposed system for synthesizing a lithium based oxide (LBO) anode material, in accordance with the embodiments of the present disclosure.

FIG. 3 illustrates schematic representation of LBO synthesis, in accordance with the embodiments of the present disclosure.

FIG. 4A illustrates cyclic voltammetry (CV) test of LTO half-cell, in accordance with the embodiments of the present disclosure.

FIG. 4B illustrates charge-discharge profile of LTO half-cell, in accordance with the embodiments of the present disclosure.

FIG. 5A illustrates cyclic voltammetry (CV) test of LVO half-cell, in accordance with the embodiments of the present disclosure.

FIG. 5B illustrates charge-discharge profile of LVO half-cell, in accordance with the embodiments of the present disclosure.

FIG. 6A illustrates Powder XRD pattern of Li₄Ti₅O₁₂, in accordance with the embodiments of the present disclosure.

FIG. 6B illustrates Galvanostatic Charge/Discharge (GCD) profile of Li₃VO₄ or Li₄Ti₅O₁₂ at 10 C-rate under 1-2.5 V, in accordance with an embodiment of the present disclosure.

FIG. 6C illustrates Ex-situ TEM scan images of Li₄Ti₅O₁₂ after cycling, in accordance with the embodiments of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternative falling within the spirit and scope of the present disclosures as defined by the appended claims.

Embodiments explained herein relate to field of battery technology. More particularly, the present disclosure relates to method and system for synthesizing of lithium based oxide (LBO) anode material for battery applications.

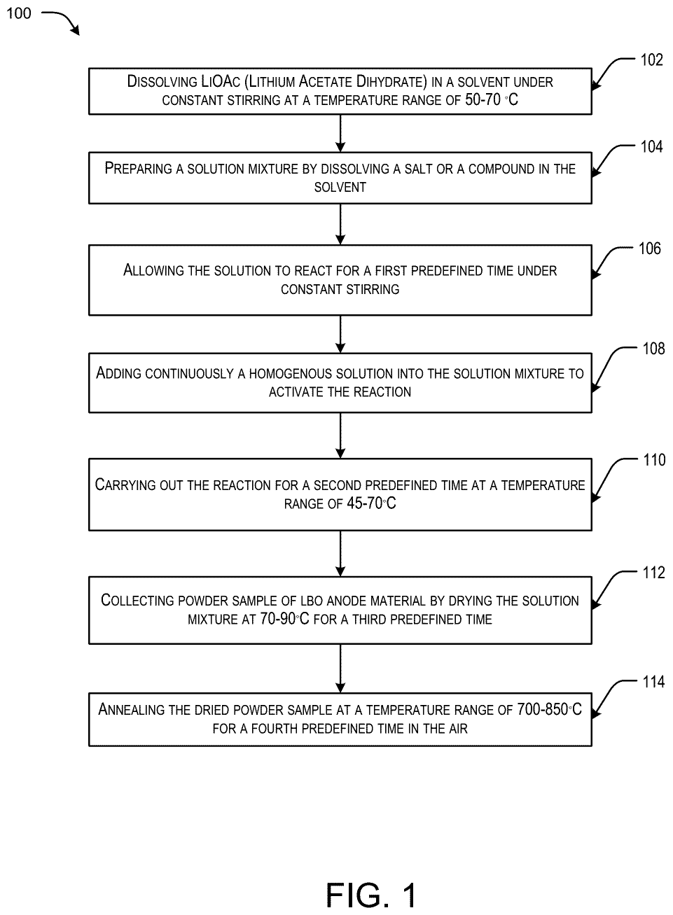

FIG. 1 illustrates an exemplary flow diagram of the proposed method 100 for synthesizing a lithium based oxide (LBO) anode material, in accordance with the embodiments of the present disclosure.

Referring to FIG. 1, in an embodiment, the proposed method 100 for synthesizing a lithium based oxide (LBO) anode material is disclosed. Method 100 can include step 102 of dissolving LiOAc (Lithium acetate dihydrate) in a solvent under constant stirring at a temperature range of 50-70° C. In addition, the method 100 can include a step 104 of preparing a solution mixture by dissolving a salt or compound in the solvent. Further, the method 100 can include step 106 of allowing the solution mixture to react for a first predefined time under constant stirring.

At step 108, the method 100 can include carrying out the reaction for a second predefined time at a temperature range of 45-70° C. under constant stirring. In addition, the method 100 can include step 110 of collecting powder sample of LBO anode material by drying the solution mixture at 70-90° C. in air for a third predefined time. Further, the method 100 can include step 112 of annealing the dried powder sample at a temperature range of 700-850° C. for a fourth predefined time in the air.

In an embodiment, the method 100 can further include conducting electrochemical measurement in a half-cell configuration on the synthesized LBO anode material to assess the performance of the synthesized LBO anode material. The half-cell configuration can be a lithium titanate oxide (Li₄Ti₅O₁₂) half-cell configuration including a CR2016 cell configuration and a Li₄Ti₅O₁₂ anode delivering an initial discharge capacity exceeding a predefined discharge capacity within a potential voltage window. In an exemplary embodiment, the predefined discharge capacity is 60 mAh/g 10 C-rate, and the potential voltage window is 1-2.5 V.

In an embodiment, the solvent is selected from a group comprising ethanol, methanol, 2-methoxy ethanol, propanol or a combination thereof and the solvent volume is in the range of 10-20 mL.

In an embodiment, the salt or compound dissolved in the solvent is selected from titanium butoxide or ammonium monovandate or a combination thereof.

In an embodiment, turbidity is observed within a fifth predefined time to indicate the activation of reaction and the homogenous solution comprises a mixture of solvent and deionized water.

In an embodiment, the lithium based oxide (LBO) anode material can be Li₃VO₄ or Li₄Ti₅O₁₂.

In an exemplary embodiment, the first predefined time can be 10-30 minutes, the second predefine time can be 12 hours, the third predefined time can be 30 minutes-1 hour, the fourth predefine time can be 3-4 hours and the fifth predetermined time can be 30 minutes.

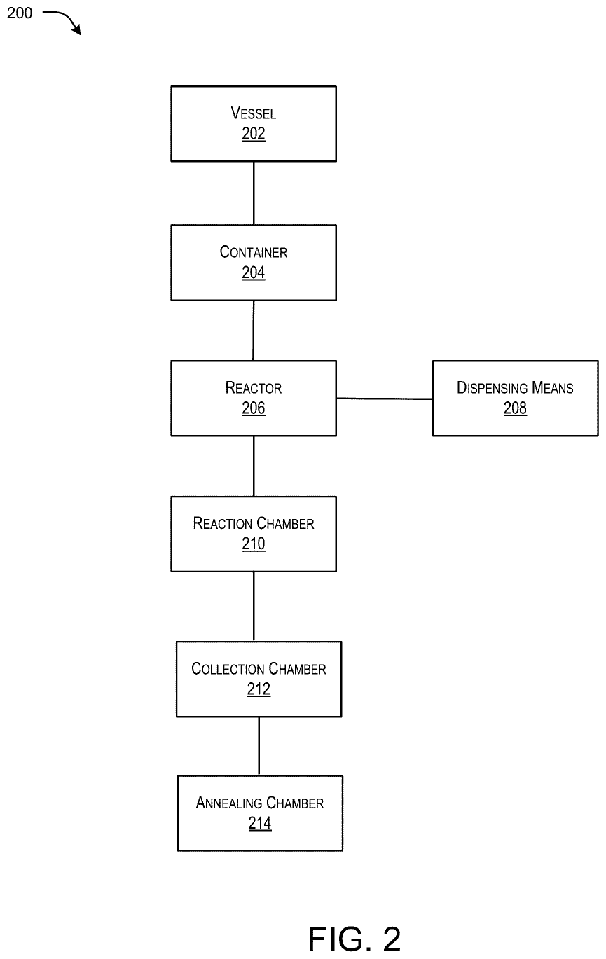

FIG. 2 illustrates an exemplary block diagram of the proposed system 200 for synthesizing a lithium based oxide (LBO) anode material, in accordance with the embodiments of the present disclosure.

Referring to FIG. 2, in an embodiment, a system 200 for synthesizing a lithium based oxide (LBO) anode material is disclosed. The system 200 can include a vessel 202 for dissolving LiOAc (Lithium acetate dihydrate) in a solvent under constant stirring at a temperature range of 50-70° C. and a container 204 for preparing a solution mixture by dissolving a salt or compound in the solvent. In addition, the system 200 can include a reactor 206 for allowing the solution mixture to react for a first predefined time under constant stirring, a dispensing means 208 for continuously adding a homogenous solution into the solution mixture to activate the reaction, and a reaction chamber 210 for carrying out the reaction for a second predefined time at a temperature range of 45-70° ° C. under constant stirring. Further, the system 200 can include a collection chamber 212 for collecting a powder sample of LBO anode material by drying the solution mixture at 70-90° C. in air for a third predefined time and an annealing chamber 214 for annealing the dried powder sample at a temperature range of 700-850° ° C. for a fourth predefined time in the air.

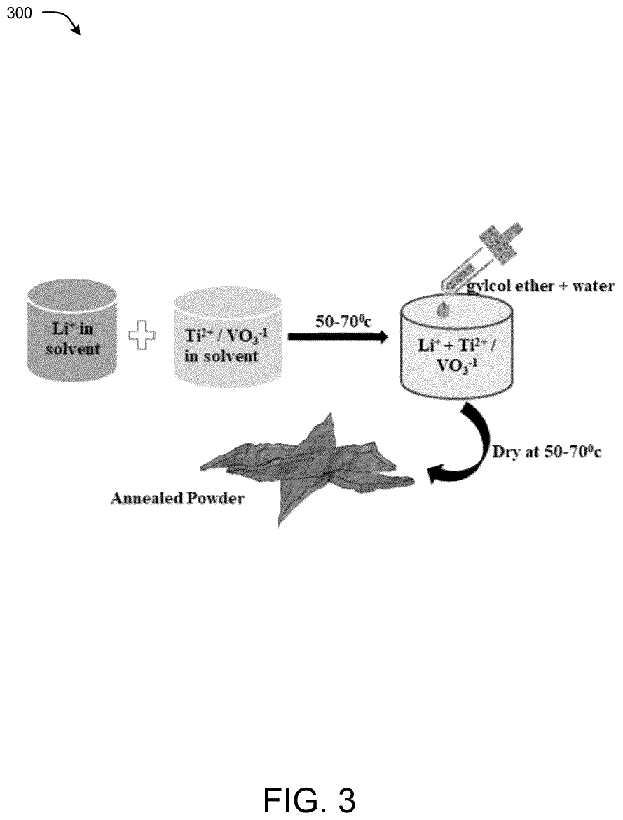

FIG. 3 illustrates schematic representation 300 of LBO synthesis, in accordance with the embodiments of the present disclosure.

Referring to FIG. 3, in an embodiment, a schematic representation 300 of LBO synthesis is shown. The LBO synthesis occurs through the sol-gel route (All above used chemicals are bought from Sigma Aldrich). The XRD, Raman, FESEM, and TEM confirmed the morphology and phase of the above-synthesized battery materials. The electrodes were fabricated by making a homogenous slurry of active materials (LBO) in a particular ratio with conductive carbon, NMP (N-Methyl-2-pyrrolidone) solvent, and binder (PVDF, CMC, SBR but not limited to this only) binder followed by slurry coating on Cu battery-grade foil. The coated slurry is placed inside the vacuum oven overnight at an elevated temperature between 60-80° C. until the residual solvent completely evaporated. Afterward, the electrodes were finally punched from the dried slurry in a disc size of 10 mm before the cell assembly.

The cell (CR2016) assembly is carried out in an argon-filled glove box with oxygen and moisture levels maintained below <0.1 ppm. A separator of 18 mm disc size (approx.) and standard solution of LiPF₆ solution (mixture of ethylene carbonate (EC) and dimethyl carbonate (DMC)) were used. Various electrochemical measurements, including cyclic voltammetry, electrochemical impedance spectroscopy (EIS), rate capability (RC), and galvanostatic charge-discharge (GCD), were performed under specific potential windows and various C-rates or current density (mA/g) corresponding to the theoretical capacity of the electrode material.

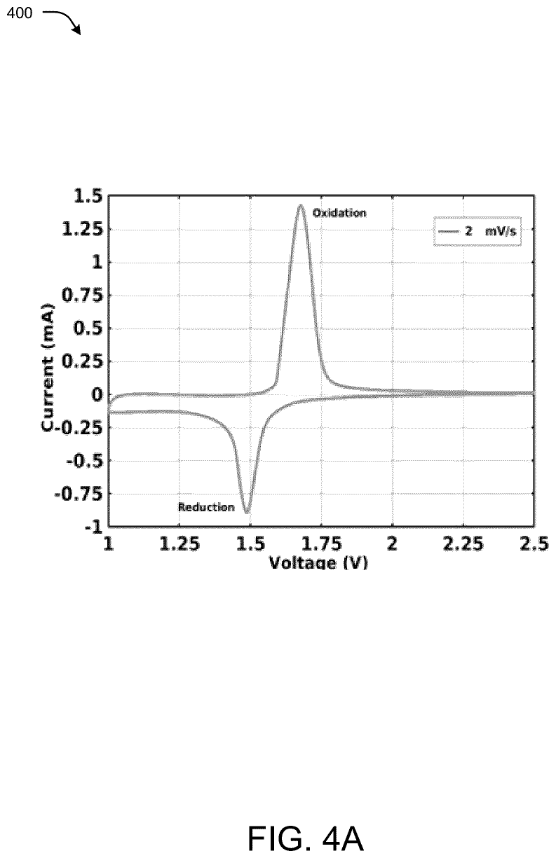

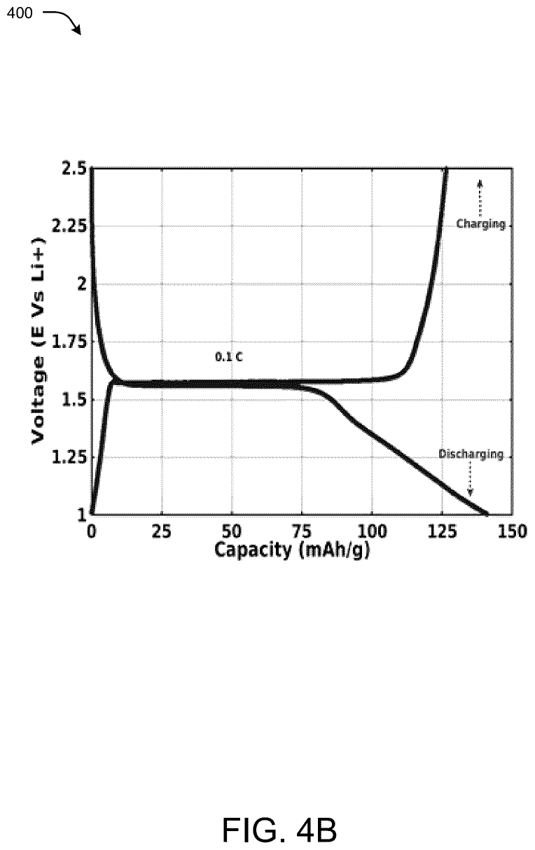

FIG. 4A illustrates cyclic voltammetry (CV) test 400 of LTO half-cell, in accordance with the embodiments of the present disclosure, and FIG. 4B illustrates charge-discharge profile 400 of LTO half-cell, in accordance with the embodiments of the present disclosure.

Referring to FIGS. 4A and 4B in an embodiment, show some initial CV and charge-discharge profile for the LTO half-cell. It is found that the LTO half-cell delivers a specific discharge capacity of ˜142 mAhg⁻¹ for the first cycle at a lower C-rate or current density (mA/g).

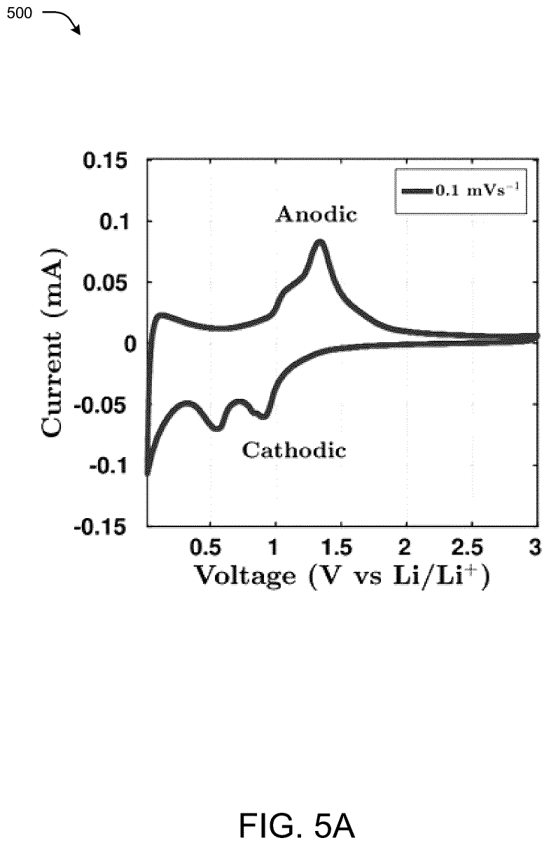

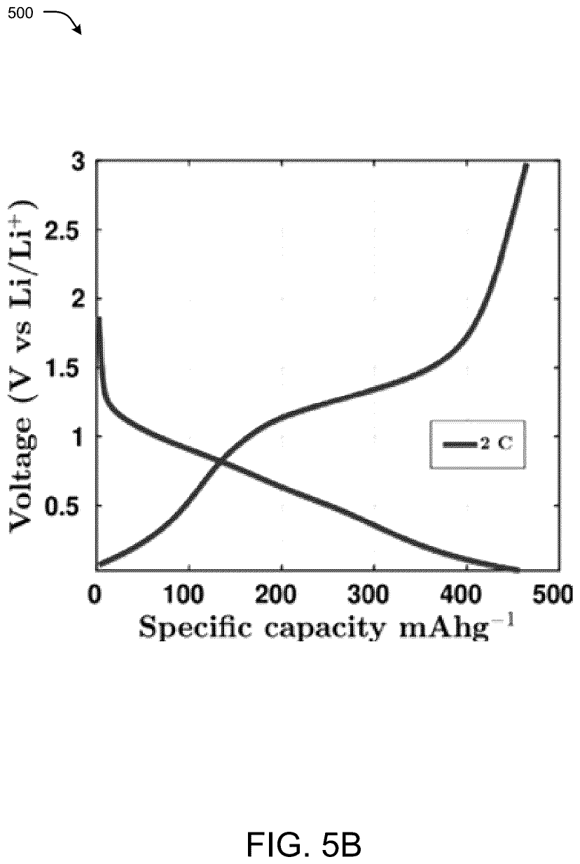

FIG. 5A illustrates cyclic voltammetry (CV) test of LVO half-cell, in accordance with the embodiments of the present disclosure, and FIG. 5B illustrates charge-discharge profile of LVO half-cell, in accordance with the embodiments of the present disclosure.

Referring to FIGS. 5A and 5B, in an embodiment, show the initial CV test and charge-discharge profile (at a higher C-rate) for the LVO cell. The cell can deliver a specific discharge capacity of ˜450 mAhg⁻¹ at a higher C-rate.

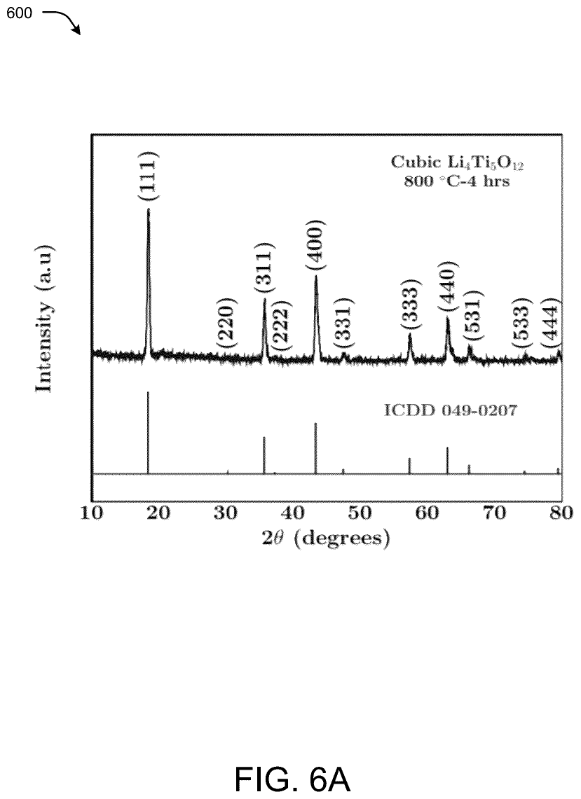

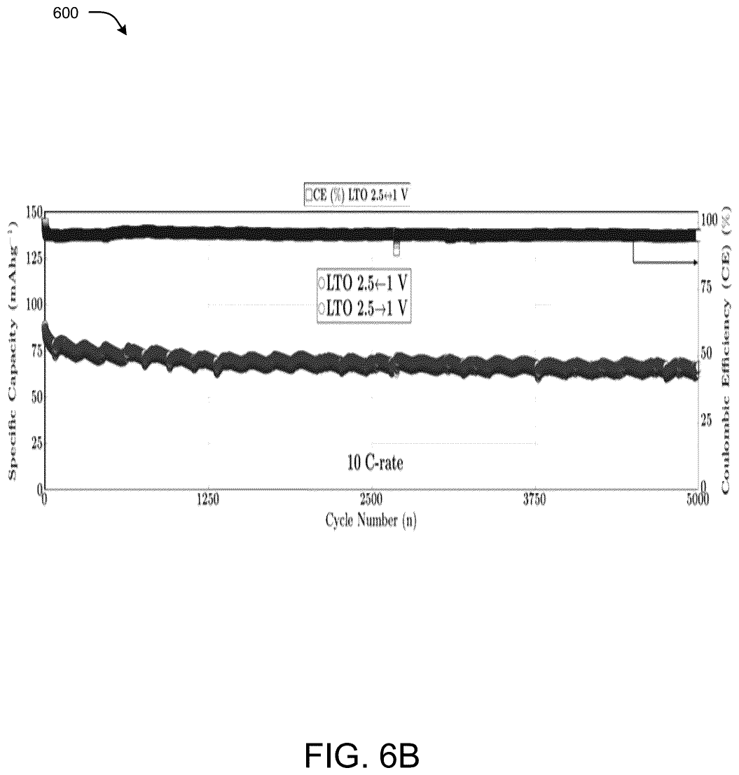

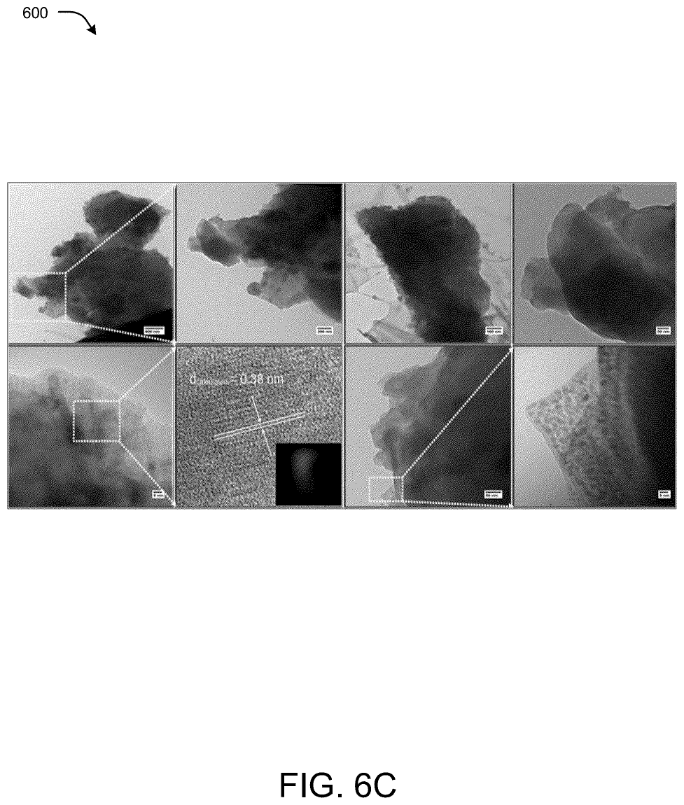

FIG. 6A illustrates Powder XRD pattern of Li₄Ti₅O₁₂, in accordance with the embodiments of the present disclosure, FIG. 6B illustrates Galvanostatic Charge/Discharge (GCD) profile of Li₄Ti₅O₁₂ at 10 C-rate under 1-2.5 V, in accordance with an embodiment of the present disclosure, and FIG. 6C illustrates Ex-situ TEM scan images of Li₄Ti₅O₁₂ after cycling, in accordance with the embodiments of the present disclosure.

Referring to FIGS. 6A, 6B and 6C, in an embodiment, show Powder XRD pattern of Li₄Ti₅O₁₂, Galvanostatic Charge/Discharge (GCD) profile of Li₄Ti₅O₁₂ at 10 C-rate under 1-2.5 V and Ex-situ TEM scan images of Li₄Ti₅O₁₂ after cycling. The electrochemical performance of the half-cell is studied separately in CR2016 cell configuration. Li₄Ti₅O₁₂ delivers initial discharge specific capacity >60 mAh/g at 10 C-rate under potential window of 1-2.5 V. The galvanostatic Charge/Discharge (GCD) profile of the LTO shows that the cell can be cycled for over 5000 cycles without any significant degradation in the capacity. The ex-situ TEM study shows the laminar morphology remains intact after cycling.

Below tables show the comparative studies of the LTO/LVO synthesis as discussed in the above prior-art references (in the background section) and the present invention:

TABLE 1
COMPARATIVE STUDY OF LTO SYNTHESIS

| | | | | | Temperature |
|---|---|---|---|---|---|
| Meth- | Materials | Quanti- | | Total | Crystal- |
| ods | (Purity >99%) | ty | Price | cost | lization |
| P1 | TiO₂ | 100 g | Rs. 3 | Rs | 500-800° C. |
| | (Anatase, | (Sigma) | 0,750 | 35,201 | For 3 hrs |
| | size <25 nm) | | | | |
| | Li₂CO₃ | 100 g | Rs. | | |
| | | (Sigma) | 4,451 | | |
| P2 | Lithium | 125 gm | Rs. | Rs | 60° C. for 12 |
| | nitrate | (Sigma) | 40,814 | 43,145 | hours followed |
| | Titanium Iso- | 100 g | Rs. | | by heating- at |
| | at propoxide | (Sigma) | 2,331 | | 300° C. |
| Present | Titanium | 100 g | Rs. | Rs. | 700-900° C. |
| Inven- | butoxide | (Sigma) | 2,391 | 7,402 | for 3-4 hrs |
| tion | Lithium | 100 g | Rs. | | |
| | acetate | (Sigma) | 5,083 | | |
| | dihydrate | | | | |

TABLE 2
COMPARATIVE STUDY OF LVO SYNTHESIS

| | | | | | Temperature |
|---|---|---|---|---|---|
| Meth- | Materials | Quanti- | | Total | Crystal- |
| ods | (Purity >99%) | ty | Price | cost | lization |
| P3 | V₂O₅ | 100 g | Rs | Rs. | 1000° C. |
| | | (Sigma) | 127,780 | 130,299.7 | For 3 hrs |
| | LiOH | 100 g | Rs. | | |
| | | (Sigma) | 2519.70 | | |
| P4 | NH₄VO₃ | 100 g | Rs. | Rs | 250-450° C. |
| | | (Sigma) | 7,800 | 51,134 | for 10-20 |
| | LiOH | 100 g | Rs. | | hrs |
| | | (Sigma) | 2,519.70 | | |
| Present | Lithium | 100 g | Rs. | Rs | 750-850° C. |
| Inven- | nitrate | (Sigma) | 40,814 | 12,943 | for 3-4 hrs |
| tion | NH₄VO₃ | 100 g | Rs. | | |
| | | (Sigma) | 7,860 | | |

As it can be clearly seen from the above table, the present invention is budget-friendly and more economical during commercialization.

The synthesis process of the present invention may also be considered as the economic way of producing large-scale production of LTO and LVO anode without any impurity as the by-product in the final resultant yield. Thus, the application of the above solution-processed LBO anode material is not limited to half-cell configuration but also full-cell configuration via specific lithiation strategy. It is a high yield and controlled stoichiometry bulk scale synthesis process of LBO anode material, Li₃VO₄/Li₄Ti₅O₁₂ without any impurities in the final product and the invention is highly economical in terms of energy consumption, the quantity of the material, surfactant-free and impurity-free route in obtaining sheet-like or laminar morphology for LTO as well as LVO.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter is to be implemented merely as illustrative of the invention and not as a limitation.

While the foregoing describes various embodiments of the invention, other and further embodiments of the invention may be devised without departing from the basic scope thereof. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a method for synthesizing a lithium based oxide (LBO) anode material that employs a controlled temperature range (50-70° C.) during LiOAc dissolution, ensuring optimal conditions for the reaction and promoting efficient dissolution of the precursor.

The present disclosure provides a method for synthesizing a lithium based oxide (LBO) anode material with predefined reaction times at different stages allow for precise control over the synthesis process, ensuring reproducibility and consistent material properties.

The present disclosure provides a method for synthesizing a lithium based oxide (LBO) anode material with specified drying and annealing conditions (temperature and time) contribute to the effective removal of solvents and the enhancement of the structural and electrochemical properties of the LBO anode material.

The present disclosure provides a method for synthesizing a lithium based oxide (LBO) anode material where synthesized Li₄Ti₅O₁₂ anode demonstrates an initial discharge capacity exceeding predefined levels at an elevated C-rate, indicating excellent electrochemical performance.

The present disclosure provides a method for synthesizing a lithium based oxide (LBO) anode material where galvanostatic Charge/Discharge (GCD) profiles reveal that the Li₄Ti₅O₁₂ half-cell can be cycled for over 5000 cycles without significant degradation in capacity, showcasing remarkable cycle life and stability.

The present disclosure provides a method for synthesizing a lithium based oxide (LBO) anode material where ex-situ Transmission Electron Microscopy (TEM) study demonstrates that the laminar morphology of the Li₄Ti₅O₁₂ anode remains intact after cycling, indicating structural robustness and resilience to repeated electrochemical cycling.

We claim:

1. A method (100) for synthesizing a lithium based oxide (LBO) anode material, said method (100) comprising the steps of:
a) dissolving (102) LiOAc (Lithium acetate dihydrate) in a solvent under constant stirring at a temperature range of 50-70° C.;
b) preparing (104) a solution mixture by dissolving a salt or compound in the solvent;
c) allowing (106) the solution mixture to react for a first predefined time under constant stirring;
d) adding (108) continuously a homogenous solution into the solution mixture to activate the reaction;
e) carrying (110) out the reaction for a second predefined time at a temperature range of 45-70° C. under constant stirring;
f) collecting (112) powder sample of LBO anode material by drying the solution mixture at 70-90° C. in air for a third predefined time; and
g) annealing (114) the dried powder sample at a temperature range of 700-850° C. for a fourth predefined time in the air.

2. The method (100) as claimed in claim 1, wherein the solvent is selected from a group comprising ethanol, methanol, 2-methoxy ethanol, propanol or a combination thereof.

3. The method (100) as claimed in claim 1, wherein the solvent volume is in the range of 10-20 mL.

4. The method (100) as claimed in claim 1, wherein the salt or compound dissolved in the solvent is selected from titanium butoxide or ammonium monovandate or a combination thereof.

5. The method (100) as claimed in claim 1, wherein turbidity is observed within a fifth predefined time to indicate the activation of reaction.

6. The method (100) as claimed in claim 1, wherein the homogenous solution comprises a mixture of solvent and deionized water.

7. The method (100) as claimed in claim 1, wherein the method further comprises conducting electrochemical measurement in a half-cell configuration on the synthesized LBO anode material to assess the performance of the synthesized LBO anode material.

8. The method (100) as claimed in claim 1, wherein the lithium based oxide (LBO) anode material is Li₃VO₄ or Li₄Ti₅O₁₂.

9. The method (100) as claimed in claim 7, wherein the half-cell configuration is a lithium titanate oxide (Li₄Ti₅O₁₂) half-cell configuration comprising:
a CR2016 cell configuration; and
a Li₄Ti₅O₁₂ anode delivering an initial discharge capacity exceeding a predefined discharge capacity within a potential voltage window.

10. A system (200) for synthesizing a lithium based oxide (LBO) anode material, said system (200) comprising:
a vessel (202) for dissolving LiOAc (Lithium acetate dihydrate) in a solvent under constant stirring at a temperature range of 50-70° C.;
a container (204) for preparing a solution mixture by dissolving a salt or compound in the solvent;
a reactor (206) for allowing the solution mixture to react for a first predefined time under constant stirring;
a dispensing means (208) for continuously adding a homogenous solution into the solution mixture to activate the reaction;
a reaction chamber (210) for carrying out the reaction for a second predefined time at a temperature range of 45-70° ° C. under constant stirring;
a collection chamber (212) for collecting a powder sample of LBO anode material by drying the solution mixture at 70-90° C. in air for a third predefined time; and
an annealing chamber (214) for annealing the dried powder sample at a temperature range of 700-850° ° C. for a fourth predefined time in the air.
